(19) United States
(12) Patent Application Publication
(10) Pub. No.: US 2017/0203434 A1
(43) Pub. Date: Jul. 20, 2017

(54) ROBOT AND ROBOT SYSTEM

(71) Applicant: Seiko Epson Corporation, Tokyo (JP)

(72) Inventor: Junya UEDA, Azumino (JP)

(21) Appl. No.: 15/404,612

(22) Filed: Jan. 12, 2017

(30) Foreign Application Priority Data
Jan. 14, 2016 (JP) 2016-005019

(51) Int. Cl. B25J 9/00; B25J 13/08; B25J 19/02

(52) U.S. Cl. CPC B25J 9/0081; B25J 19/023; B25J 13/085; G05B 2219/39054

(57) ABSTRACT

A robot includes an arm. The robot moves the arm on the basis of a detected position, which is a position of a target object detected by a detecting section, and a stored position, which is a position of the target object stored by a storing section.

### BACKGROUND

1. Technical Field

The present invention relates to a robot and a robot system.

2. Related Art

Researches and developments of a method for teaching a robot control device, which operates a robot, about a motion of the robot have been performed.

Concerning the method, there is known a direct teaching device that causes a user to manually operate a robot and causes a robot control device to store the position and the posture of the robot (see JP-A-08-216074 (Patent Literature 1)).

However, the robot control device taught about the motion of the robot by the direct teaching device matches the position and the posture of an arm of the robot with the taught position and posture. Therefore, when positional deviation occurs between the position of a target object at the time when the teaching is performed and the position of the target object at the time when the robot is operated, accuracy of work by the robot is sometimes deteriorated.

### SUMMARY

An aspect of the invention is directed to a robot including an arm. The robot moves the arm on the basis of a detected position, which is a position of a target object detected by a detecting section, and a stored position, which is a position of the target object stored by a storing section.

With this configuration, the robot moves the arm on the basis of the detected position, which is the position of the target object detected by the detecting section, and the stored position, which is the position of the target object stored by the storing section. Consequently, even when positional deviation between the detected position and the stored position occurs, the robot can suppress accuracy of work from being deteriorated.

Another aspect of the invention is directed to the robot, in which the detected position and the stored position are positions based on at least one of a part of the target object and a marker provided in the target object.

With this configuration, the robot moves the arm on the basis of the detected position and the stored position, which are the positions based on at least one of a part of the target object and the marker provided in the target object. Consequently, even when positional deviation occurs between the detected position and the stored position, which are the positions based on at least one of a part of the target object and the marker provided in the target object, the robot can suppress accuracy of work from being deteriorated.

Another aspect of the invention is directed to the robot, in which the detecting section is an image pickup section, and the detected position is detected on the basis of a picked-up image picked up by the image pickup section.

With this configuration, the robot moves the arm on the basis of the detected position detected on the basis of the picked-up image picked up by the image pickup section and the stored position. Consequently, even when positional deviation between the detected position detected on the basis of the picked-up image picked up by the image pickup section and the stored position occurs, the robot can suppress accuracy of work from being deteriorated.

Another aspect of the invention is directed to the robot, in which the robot moves the target object with the arm.

With this configuration, the robot moves the target object with the arm. Consequently, even when positional deviation between the detected position and the stored position occurs, the robot can suppress accuracy of work for moving the target object with the arm from being deteriorated.

Another aspect of the invention is directed to the robot, in which the robot further includes a force detecting section configured to detect a force, and teaching point information including position information, which is information indicating a position, is stored in the storing section according to teaching by direct teaching based on an output of the force detecting section.

With this configuration, the teaching point information including the position information, which is the information indicating the position, is stored in the storing section according to the teaching by the direct teaching based on the output of the force detecting section. Consequently, the robot can move the arm on the basis of the teaching point information stored according to the teaching by the direct teaching.

Another aspect of the invention is directed to the robot, in which the teaching point information is stored in the storing section every time a predetermined time elapses in the teaching.

With this configuration, the teaching point information is stored in the storing section every time the predetermined time elapses in the teaching by the direct teaching. Consequently, the robot can move the arm on the basis of the teaching point information stored in the storing section every time the predetermined time elapses in the teaching by the direct teaching.

Another aspect of the invention is directed the robot, in which the robot moves the arm according to position control for matching a control point, which is a position associated with the arm, with the position indicated by the position information.

With this configuration, the robot moves the arm according to the position control for matching the control point, which is the position associated with the arm, with the position indicated by the position information. Consequently, the robot can suppress accuracy of work performed by the position control from being deteriorated.

Another aspect of the invention is directed to the robot, in which the robot moves the arm according to the position control and control based on the output of the force detecting section.

With this configuration, the robot moves the arm according to the position control and the control based on the output of the force detecting section. Consequently, the robot can suppress accuracy of work performed according to the position control and the control based on the output of the force detecting section from being deteriorated.

Another aspect of the invention is directed to the robot, in which the robot performs at least one of starting of the teaching and ending of the teaching on the basis of the output of the force detecting section.

With this configuration, the robot performs at least one of the starting of the teaching by the direct teaching and the ending of the teaching by the direct teaching on the basis of the output of the force detecting section. Consequently, the robot can improve efficiency of work.

Another aspect of the invention is directed to the robot, in which the robot moves the arm on the basis of positional deviation between the detected position and the stored position and the teaching point information.

With this configuration, the robot moves the arm on the basis of the positional deviation between the detected position and the stored position and the teaching point information. Consequently, the robot can suppress, on the basis of the positional deviation between the detected position and the stored position and the teaching point information, accuracy of work from being deteriorated.

Another aspect of the invention is directed to the robot, in which the robot corrects the teaching point information on the basis of the positional deviation and move the arm.

With this configuration, the robot corrects the teaching point information on the basis of the positional deviation and moves the arm. Consequently, the robot can suppress, on the basis of the corrected teaching point information, accuracy of work from being deteriorated.

Another aspect of the invention is directed to the robot, in which the robot corrects the teaching point information according to coordinate conversion.

With this configuration, the robot corrects the teaching point information according to the coordinate conversion. Consequently, the robot can suppress, on the basis of the teaching point information corrected according to the coordinate conversion, accuracy of work from being deteriorated.

Another aspect of the invention is directed to the robot, in which the robot moves the arm on the basis of a detected posture, which is a posture of the target object detected by the detecting section, and the detected position and a stored posture, which is a posture of the target object stored by the storing section, and the stored position.

With this configuration, the robot moves the arm on the basis of the detected posture, which is the posture of the target object detected by the detecting section, and the detected position and the stored posture, which is the posture of the target object stored by the storing section, and the stored position. Consequently, even when positional deviation between the detected position and the stored position and postural deviation between the detected posture and the stored posture occur, the robot can suppress accuracy of work from being deteriorated.

Another aspect of the invention is directed to a robot system including: the robot described above; and a robot control device configured to control the robot.

With this configuration, the robot system moves an arm on the basis of a detected position, which is a position of a target object detected by a detecting section, and a stored position, which is a position of the target object stored by the storing section. Consequently, even when positional deviation occurs between the detected position and the stored position, the robot system can suppress accuracy of work from being deteriorated.

As explained above, the robot and the robot system moves the arm on the basis of the detected position, which is the position of the target object detected by the detecting section, and the stored position, which is the position of the target object stored by the storing section. Consequently, even when positional deviation between the detected position and the stored position occurs, the robot and the robot system can suppress accuracy of work from being deteriorated.

### BRIEF DESCRIPTION OF THE DRAWINGS

The invention will be described with reference to the accompanying drawings, wherein like numbers reference like elements.

FIG. 1 is a diagram showing an example of the configuration of a robot system according to a first embodiment.

FIG. 2 is a diagram showing an example of a state in which a robot is polishing an outer peripheral portion of a target object using a tool.

FIG. 3 is a diagram showing an example of a hardware configuration of a robot control device.

FIG. 4 is a diagram showing an example of a functional configuration of the robot control device.

FIG. 5 is a flowchart for explaining an example of a flow of processing in which the robot control device in the first embodiment causes the robot to perform first work.

FIG. 6 is a flowchart for explaining an example of a flow of processing in which the robot control device in the first embodiment stores reference position and posture information and teaching point information.

FIG. 7 is a diagram showing a state in which the target object and a work part are set in contact with each other according to teaching by direct teaching after processing in step S140 is started.

FIG. 8 is a diagram showing an example of the configuration of the robot system according to a second embodiment.

FIG. 9 is a diagram showing an example of a state in which the robot is polishing the inner peripheral surface of a target object using a tool.

FIG. 10 is a flowchart for explaining an example of a flow of processing in which the robot control device in the second embodiment causes the robot to perform second work.

FIG. 11 is a flowchart for explaining a flow of processing in which the robot control device in the second embodiment stores reference position and posture information and teaching point information.

FIG. 12 is a diagram showing an example of a state in which the target object and a polishing section of the tool are set in contact with each other according to teaching by direct teaching after processing in step S340 is started.

### DESCRIPTION OF EXEMPLARY EMBODIMENTS

### First Embodiment

A first embodiment of the invention is explained below with reference to the drawings.

### Configuration of a Robot System

First, the configuration of a robot system 1 explained.

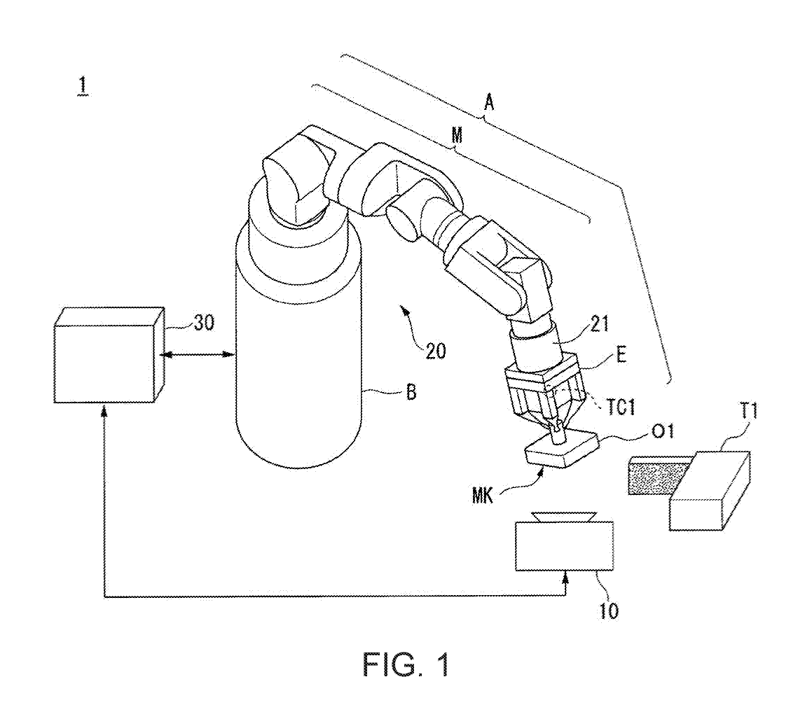

FIG. 1 is a diagram showing an example of the configuration of the robot system 1 according to the first embodiment. The robot system 1 includes an image pickup section 10, a robot 20, and a robot control device 30.

The image pickup section 10 is a camera including, for example, a CCD (Charge Coupled Device) or a CMOS (Complementary Metal Oxide Semiconductor), which is an image pickup device that converts condensed light into an electric signal. In this example, the image pickup section 10 is set in a position where the image pickup section 10 is capable of picking up an image of a range including a region where the robot 20 is capable of performing work.

The image pickup section 10 is communicably connected to the robot control device 30 by a cable. Wired communication via the cable is performed by a standard such as the Ethernet (registered trademark) or the USB (Universal Serial Bus). Note that the image pickup section 10 may be connected to the robot control device 30 by wireless communication performed according to a communication standard such as the Wi-Fi (registered trademark). The image pickup section 10 is an example of a detecting section.

The robot 20 is a single-arm robot including an arm A and a supporting stand B that supports the arm A. The single-arm robot is a robot including one arm like the arm A in this example. Note that the robot 20 may be a plural-arm robot instead of the single-arm robot. The plural-arm robot is a robot including two or more arms (e.g., two or more arms A). Note that, among plural arm robots, a robot including two arms is referred to as double-arm robot as well. That is, the robot 20 may be a double-arm robot including two arms or may be a plural-arm robot including three or more arms (e.g., three or more arms A).

The arm A includes an end effector E, a manipulator M, and a force detecting section 21.

In this example, the end effector E is an end effector including finger sections capable of gripping an object. Note that the end effector E may be another end effector capable of lifting an object with the suction of the air, a magnetic force, a jig, or the like instead of the end effector including the finger sections.

In this example, in the position of the center of gravity of the end effector E, a control point TC1, which is a TCP (Tool Center Point) moving together with the center of gravity, is set. Note that the position where the control point TC1 is set may be another position associated with the end effector E instead of the position of the center of gravity of the end effector E. In this example, the position of the center of gravity represents the position of the end effector E. Note that the position of the end effector E may be represented by another position associated with the end effector E instead of the position of the center of gravity.

At the control point TC1, a control point coordinate system TC, which is a three-dimensional local coordinate system representing the position and the posture of the control point TC1 (i.e., the position and the posture of the end effector E), is set. The position and the posture of the control point TC1 means the position and the posture of the control point TC1 in a robot coordinate system. The origin of the control point coordinate system TC represents the position of the control point TC1, that is, the position of the end effector E. The directions of coordinate axes of the control point coordinate system TC represent the posture of the control point TC1, that is, the posture of the end effector E. In the following explanation, as an example, a Z axis in the control point coordinate system TC and a rotation axis of a joint that rotates the end effector E among joints of the manipulator M provided with the end effector E are matched. In this example, the joint is a joint closest to an end portion on the opposite side of the supporting stand B of end portions of the manipulator M.

The end effector E is communicatively connected to the robot control device 30 by a cable. Consequently, the end effector E performs a motion based on a control signal acquired from the robot control device 30. Note that wired communication via the cable is performs according to a standard such as the Ethernet (registered trademark) or the USB. The end effector E may be connected to the robot control device by wireless communication performed according to a communication standard such as the Wi-Fi (registered trademark).

The manipulator M includes seven joints including the joint that rotates the end effector E. The seven joints respectively include not-shown actuators. That is, the arm A including the manipulator M is an arm of a seven-axis vertical multi-joint type. The arm A performs a motion of a seven-axis degree of freedom according to associated operation by the supporting stand B, the end effector E, the manipulator M, and the actuators of the respective seven joints included in the manipulator M. Note that the arm A may move at a degree of freedom of six or less axes or may move at a degree of freedom of eight or more axes.

When the arm A moves at the seven-axis degree of freedom, postures that the arm A can take increases compared with when the arm A moves at the degree of freedom of six or less axes. Consequently, the arm A can move smoothly and easily avoid interference with an object present around the arm A. When the arm A moves at the seven-axis degree of freedom, computational complexity of the control of the arm A is small and the control of the arm A is easy compared with when the arm A moves at the degree of freedom of eight or more exes.

The seven actuators (included in the joints) included in the manipulator M are respectively communicably connected to the robot control device 30 by cables. Consequently, the actuators operate the manipulator M on the basis of a control signal acquired from the robot control device 30. Note that the wired communication via the cable is performed according to a standard such as the Ethernet (registered trademark) or the USB. A part or all of the seven actuators included in the manipulator M may be connected to the robot control device 30 by wireless communication performed according to a communication standard such as the Wi-Fi (registered trademark).

The force detecting section 21 is provided between the end effector E and the manipulator M. The force detecting section 21 is, for example, a force sensor. The force detecting section 21 detects a force or a moment (torque) acting on the end effector E or an object gripped by the end effector E. The force detecting section 21 outputs force detection information including, as an output value, a value indicating the magnitude of the detected force or moment to the robot control device 30 through communication.

The force detection information is used for control based on force detection information of the arm A by the robot control device 30. The control based on the force detection information means, for example, compliant motion control such as impedance control. Note that the force detecting section 21 may be another sensor such as a torque sensor that detects the value indicating the magnitude of the force or the moment applied to the end effector E or the object gripped by the end effector E.

The force detecting section 21 is communicably connected to the robot control device 30 by a cable. Wired communication via the cable is performed according to a standard such as the Ethernet (registered trademark) or the USB. Note that the force detecting section 21 and the robot control device 30 may be connected via a force sensor interface unit. The force detecting section 21 and the robot control device 30 may be connected by wireless communication performed according to a communication standard such as the Wi-Fi (registered trademark).

The robot control device 30 transmits a control signal to the robot 20 to thereby operate the robot 20. Consequently, the robot control device 30 causes the robot 20 to perform predetermined work. Note that the robot control device 30 may be incorporated in the robot 20 instead of being set on the outside of the robot 20.

### Overview of the Predetermined Work Performed by the Robot

Overview of first work, which is the predetermined work performed by the robot 20 in the first embodiment, is explained below. In FIG. 1, the robot 20 grips the target object O1 in advance with the end effector E. Note that the robot 20 may grip the target object O1 disposed in a predetermined material supply region without gripping the target object O1 in advance.

The target object O1 is, for example, an industrial component, member, or product. In the following explanation, as an example, the target object O1 is a component formed by two parts, that is, a plate part, which is a tabular part, and a cylinder part, which is a cylindrical part. The plate part is a part having a rectangular flat plate shape rounded at four corners. The cylinder part is formed on one of two surfaces of the rectangular shape of the target object O1. The center axis of the cylinder part passes the center of the surface. A marker MK is provided on a surface opposed to the surface on which the cylinder part is provided of the surfaces of the target object O1.

The marker MK is a mark indicating a first target object coordinate system, which is a three-dimensional local coordinate system representing the position and the posture of the target object O1. The position and the posture of the target object O1 means the position and the posture of the target object O1 in the robot coordinate system. The position of the origin of the first target object coordinate system represents, for example, as the position of the target object O1, the position of the center of gravity of the target object O1. The directions of respective coordinate axes of the first target object coordinate system represent the posture of the target object O1.

Note that the marker MK may be any mark as long as the mark can indicate the first target object coordinate system. The marker MK may be apart of the target object O1. The target object O1 may be, instead the industrial component shown in FIG. 1, another object such as another component, member, or product different from the industrial one or an organism. The shape of the target object O1 may be another form instead of the shape explained above.

In the example shown in FIG. 1, the robot 20 grips the cylinder part of the target object O1 with the end effector E. Note that the robot 20 may grip another part of the target object O1 instead of the cylinder part.

As the first work, the robot 20 in this example polishes the outer peripheral portion of the target object O1 using a tool T1. The outer peripheral portion of the target object O1 means a side surface when one of the two surfaces of the rectangular shape of the plate part of the target object O1 (e.g., the surface on which the cylinder part is provided) is regarded as an upper surface and the other surface is regarded as a lower surface. The tool T1 is, for example, a belt sander that polishes the surface of an object by turning a polishing belt. The tool T1 is set (fixed), to prevent the position and the posture of the tool T1 in the robot coordinate system from changing, on a setting surface such as a table or a floor surface in a region where the robot 20 is capable of performing work.

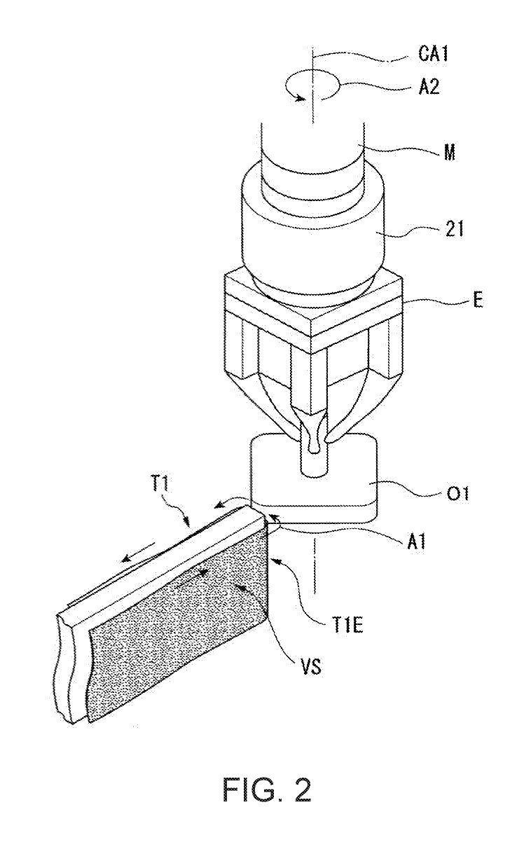

Operation of the robot 20 for polishing the outer peripheral portion of the target object O1 using the tool T1 in the first work is explained with reference to FIG. 2. FIG. 2 is a diagram showing an example of a state in which the robot 20 is polishing the outer circumference portion of the target object O1 using the tool T1.

In the example shown in FIG. 2, a polishing belt VS of the tool T1 rotates in a direction A1, which is a direction indicated by an arrow shown in FIG. 2, around a member that supports the polishing belt VS. For example, when the tool T1 is viewed in a negative direction of the Z axis in the robot coordinate system, the direction A1 is a direction in which the tool T1 rotates counterclockwise. That is, in this example, a polishing surface of the polishing belt VS is orthogonal to an XY plane in the robot coordinate system. Note that the direction A1 may be another direction instead of this direction.

The robot 20 brings the outer peripheral portion of the target object O1 gripped by the end effector E into contact with the polishing belt VS of the tool T1 to thereby polish the outer peripheral portion of the target object O1. In this example, the robot 20 brings a part of the outer peripheral portion into contact with a work part T1E. The work part T1E is a part formed in the tool T1 in order to bring an object into contact with the polishing belt VS. The robot 20 changes the position and the posture of the control point TC1 such that a portion of the outer peripheral portion in contact with the work part T1E turns around from the part along the outer peripheral portion. That is, the part is a start point portion, which is a portion serving as a start point where the outer peripheral portion starts to be polished in the outer peripheral portion. In this way, as the first work, the robot 20 polishes the outer peripheral portion of the target object O1 with the tool T1.

When the robot 20 polishes the outer peripheral portion of the target object O1 with the tool T1 in the first work, the robot control device 30 reads out teaching point information stored in advance. The teaching point information is information in which position information, posture information, and order information are associated with one another. The position information is information indicating a relative position of a position indicating a teaching point, which is a point with which the control point TC1 is matched when the robot 20 moves the arm A, relative to a reference position, which is a position serving as a reference. The posture information is information indicating a relative posture of a posture of the control point TC1 in the position relative to a reference posture, which is a posture serving as a reference. The order information is information indicating order for matching the control point TC1 with the positions. The robot control device 30 causes the robot 20 to polish the outer peripheral portion of the target object O1 with the tool T1 by moving the arm A according to position control on the basis of the read-out teaching point information to thereby change the position and the posture of the control point TC1, that is, the position and the posture of the end effector E.

The position control is control for moving the arm A by matching the position of the control point TC1 with positions (i.e., teaching points) indicated by the position information included in the teaching point information. Specifically, the position control in this example is control for moving the arm A by, in the order indicated by the order information included in the teaching point information, matching the position of the control point TC1 with the positions (i.e., the teaching points) indicated by the position information included in the teaching point information and matching the posture of the control point TC1 with postures indicated by the posture information included in the teaching point information.

The robot control device 30 stores the teaching point information according to teaching by direct teaching. The teaching by the direct teaching in this example is teaching in which a user manually changes the position and the posture of the control point TC1 of the arm A of the robot 20 and causes the robot control device 30 to store teaching point information based on the changed position and the changed posture. In the following example, as an example, in such direct teaching, the robot control device 30 changes the position and the posture of the control point TC1 according to control based on a force detected by the force detecting section 21, that is, a force manually applied to the end effector E by the user. Note that, instead of this, the robot control device 30 may change the position and the posture of the control point TC1 according to control based on an output of a torque sensor or an electric current of a servo motor. Note that, instead of storing the teaching point information according to the teaching by the direct teaching, the robot control device 30 may store the teaching point information according to another method such as teaching by online teaching.

In this example, the reference position is the position of the target object O1, that is, the position of the marker MK at the time when the position of the control point TC1 coincides with an initial position during the teaching of the teaching point information by the direct teaching. The initial position means a position with which the position of the control point TC1 is matched first during the teaching of the teaching point information by the direct teaching and during the first work. The initial position may be any position as long as the position is a position where the image pickup section 10 is capable of picking up an image of the marker MK provided in the target object O1 gripped by the end effector E. The reference posture is the posture (an initial posture) of the control point TC1, that is, the posture of the marker MK at the time when the position of the control point TC1 coincides with the initial position during the teaching of the teaching point information by the direct teaching.

When the position and the posture of the target object O1 at the time when the position and the posture of the control point TC1 coincide with the initial position and the initial posture during the first work and the reference position and the reference posture coincide with each other, the robot control device 30 can cause the robot 20 to polish the outer peripheral portion of the target object O1 with the tool T1 by moving the arm A according to the position control on the basis of the read-out teaching point information to thereby change the position and the posture of the control point TC1, that is, the position and the posture of the end effector E.

However, actually, the reference position and the reference posture and the position and the posture of the target object O1 at the time when the position and the posture of the control point TC1 coincide with the initial position and the initial posture during the first work do not always coincide with each other because of an error or the like that occurs when the target object O1 is gripped by the end effector E. In this case, if the robot control device 30 moves the robot 20 on the basis of the teaching point information stored in advance, accuracy of the first work by the robot 20 is deteriorated.

Therefore, the robot control device 30 in this example matches the position and the posture of the control point TC1 with the initial position and the initial posture during the first work and thereafter performs image pickup with the image pickup section 10 with an image pickup range set in a range including the marker MK provided in the target object O1. The robot control device 30 detects the position and the posture of the target object O1 on the basis of the marker MK included in a picked-up image. Note that, instead of detecting a detected position on the basis of the picked-up image picked-up by the image pickup section 10, which is an example of a detecting section in this example, the robot control device 30 may detect the detected position by using a laser sensor, a contact sensor, a force sensor, or the like as the detecting section. The robot control device 30 calculates positional deviation, which is deviation between the detected position, which is the position detected by the detecting section, and the reference position stored in advance, and calculates postural deviation, which is deviation between a detected posture, which is the posture detected by the detecting section, and the reference posture stored in advance.

The robot control device 30 corrects the read teaching point information on the basis of the calculated positional deviation and the calculated postural deviation, moves the arm A on the basis of the corrected teaching point information, and causes the robot 20 to perform the first work. Consequently, in the first work, even when positional deviation between the detected position and the reference position and postural deviation between the detected posture and the reference posture occur, the robot control device 30 can suppress accuracy of the first work from being deteriorated. Note that the reference position is an example of a stored position. The reference posture is an example of a stored posture.

When turning around, from the start point portion along the outer peripheral portion, the portion in contact with the work part T1E in the outer peripheral portion of the target object O1 during the first work, the robot control device 30 rotates, according to the position control and control based on the force detection information acquired from the force detecting section 21, in a direction A2, which is a direction indicated by an arrow shown in FIG. 2, an actuator that rotates a flange included in the manipulator M, that is, a flange to which the end effector E is attached. The robot control device 30 causes the actuator to push the target object O1 toward a direction approaching the work part T1E. Consequently, the robot control device 30 can suppress the target object O1 from being unintentionally deformed by the tool T1 because of an error in the position control. A rotation axis CA1 shown in FIG. 2 is a rotation axis of the actuator. The direction A2 is a direction opposite to the turning direction indicated by the direction A1.

In this example, the direction A1 and the direction A2 are respectively directions along the XY plane in the robot coordinate system. Therefore, when some part of the outer peripheral portion of the target object O1 is in contact with the work part T1E, the force detecting section 21 detects at least one of a force toward a direction along an X axis in the control point coordinate system TC and a force toward a direction along a Y axis in the control point coordinate system TC. Note that the robot control device 30 may cause the robot 20 to polish the outer peripheral portion of the target object O1 with the tool T1 according to only the position control.

In the following explanation, processing in which the robot control device 30 moves the arm A on the basis of the detected position and the detected posture and the reference position and the reference posture in causing the robot 20 to perform the first work is explained in detail. Note that, instead of detecting the position and the posture of the target object O1 on the basis of (the marker MK included in) a picked-up image picked up by the image pickup section 10, the robot control device 30 may detect the position and the posture with another means such as a sensor that detects the position and the posture with a laser, an infrared ray, or the like. In the following explanation, processing in which the robot control device 30 stores the reference position, the reference posture, and the teaching point information is explained.

### Hardware Configuration of the Robot Control Device

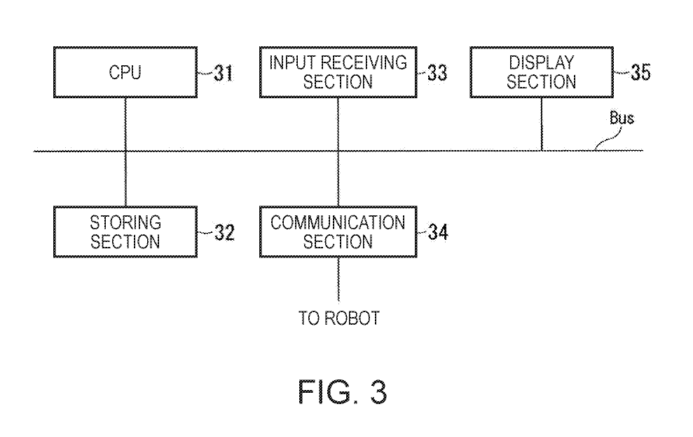

A hardware configuration of the robot control device 30 is explained with reference to FIG. 3. FIG. 3 is a diagram showing an example of the hardware configuration of the robot control device 30. The robot control device 30 includes, for example, a CPU (Central Processing Unit) 31, a storing section 32, an input receiving section 33, a communication section 34, and a display section 35. The robot control device 30 performs communication with the robot 20 via the communication section 34. These components are communicatively connected to one another via a bus Bus.

The CPU 31 executes various computer programs stored in the storing section 32.

The storing section 32 includes, for example, an HDD (Hard Disk Drive) or an SSD (Solid State Drive), an EEPROM (Electrically Erasable Programmable Read-Only Memory), a ROM (Read-Only Memory), or a RAM (Random Access Memory). Note that the storing section 32 may be an externally storage device connected by a digital input/output port such as the USB instead of a storage device incorporated in the robot control device 30. The storing section 32 stores various kinds of information and images processed by the robot control device 30, computer programs, teaching point information, reference position and posture information indicating the reference position and the reference posture, and the like. In this example, the reference position and posture information is information indicating the reference position and the reference posture with a three-dimensional local coordinate system, the position of the origin of which is the reference position, having a coordinate axis representing the reference posture at the origin. Note that, instead of this information, the reference position and posture information may be another kind of information indicating the reference position and the reference posture.

The input receiving section 33 is, for example, a keyboard, a mouse, a teaching pendant including a touch pad, or another input device. Note that the input receiving section 33 may be configured integrally with the display section 35 as a touch panel.

The communication section 34 includes, for example, a digital input/output port such as the USB or an Ethernet (registered trademark) port.

The display section 35 is, for example, a liquid crystal display panel or an organic EL (Electro Luminescence) display panel.

### Functional Configuration of the Robot Control Device

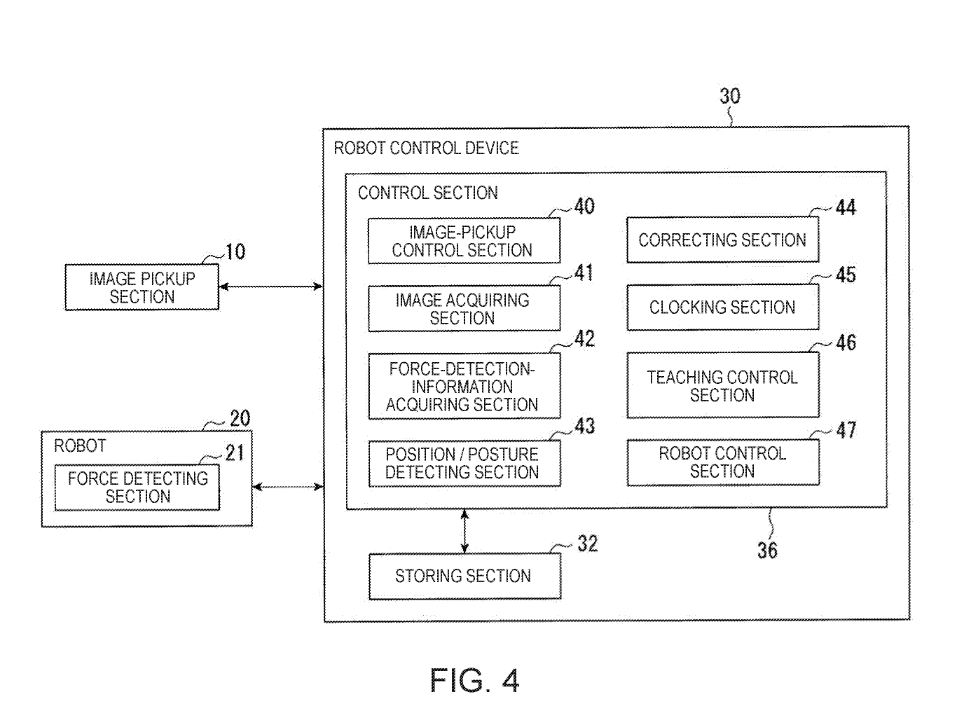

A functional configuration of the robot control device 30 is explained with reference to FIG. 4. FIG. 4 is a diagram showing an example of the functional configuration of the robot control device 30. The robot control device 30 includes a storing section 32 and a control section 36.

The control section 36 controls the entire robot control device 30. The control section 36 includes an image-pickup control section 40, an image acquiring section 41, a force-detection-information acquiring section 42, a position/posture detecting section 43, a correcting section 44, a clocking section 45, a teaching control section 46, and a robot control section 47. These functional sections included in the control section 36 are realized by, for example, the CPU 31 executing various computer programs stored in the storing section 32. A part or all of the functional sections may be hardware functional sections such as an LSI (Large Scale Integration) and an ASIC (Application Specific Integrated Circuit).

The image-pickup control section 40 causes the image pickup section 10 to pickup an image of an image pickup range.

The image acquiring section 41 acquires the picked-up image picked up by the image pickup section 10 from the image pickup section 10.

The force-detection-information acquiring section 42 acquires the force detection information from the force detecting section 21.

The position/posture detecting section 43 detects the position and the posture of the target object O1 as a detected position and a detected posture on the basis of the marker MK included in the picked-up image acquired by the image acquiring section 41. For example, the position/posture detecting section 43 detects the detected position and the detected posture according to pattern matching or the like.

The correcting section 44 reads out the reference position and posture information from the storing section 32. The correcting section 44 corrects, on the basis of the reference position and posture information read out from the storing section 32, the teaching point information stored in the storing section 32.

The clocking section 45 clocks time.

The teaching control section 46 performs starting of the teaching by the direct teaching on the basis of the force detection information acquired by the force-detection-information acquiring section 42. The teaching control section 46 performs ending of the teaching by the direct teaching on the basis of the force detection information acquired by the force-detection-information acquiring section 42. From the start of the teaching by the direct teaching to the end of the teaching, every time a predetermined time elapses according to the clocking by the clocking section 45, the teaching control section 46 causes the storing section 32 to store teaching point information in which position information indicating a relative position of the present position of the control point TC1 relative to the reference position, posture information indicating a relative posture of the present posture of the control point TC1 relative to the reference posture, and the present time are associated with one another. That is, in this example, the present time is order information. In this example, the predetermined time is 0.5 second. Note that, instead of this time, the predetermined time may be another time. Instead of the present time, the order information may be another kind of information such as numbers indicating order for matching the control point TC1 with teaching points. Instead of causing the storing section 32 to store the teaching point information every time the predetermined time elapses according to the clocking by the clocking section 45 from the start of the teaching by the direct teaching to the end of the teaching, the teaching control section 46 may cause the storing section 32 to store the teaching information at another timing. In this case, for example, the teaching control section 46 causes the storing section 32 to store the teaching point information every time the teaching control section 46 receives, via the input receiving section 33 or the teaching pendant, operation for causing the storing section 32 to store the teaching point information. Instead of performing the starting of the teaching by the direct teaching and the ending of the teaching by the direct teaching on the basis of the force detection information acquired by the force-detection-information acquiring section 42, the teaching control section 46 may perform one of the starting of the teaching by the direct teaching and the ending of the teaching by the direct teaching on the basis of the force detection information acquired by the force-detection-information acquiring section 42. In this case, the teaching control section 46 performs, on the basis of the operation received via the input receiving section 33 or the teaching pendant, the starting of the teaching by the direct teaching or the ending of the teaching by the direct teaching not performed on the basis of the force detection information.

The robot control section 47 matches the position and the posture of the control point TC1 with the initial position and the initial posture stored in advance. The robot control section 47 reads out the teaching point information from the storing section 32. The robot control section 47 causes the robot 20 to perform predetermined work on the basis of the teaching point information corrected by the correcting section 44.

Processing in which the Robot Control Device Causes the Robot to Perform the First Work

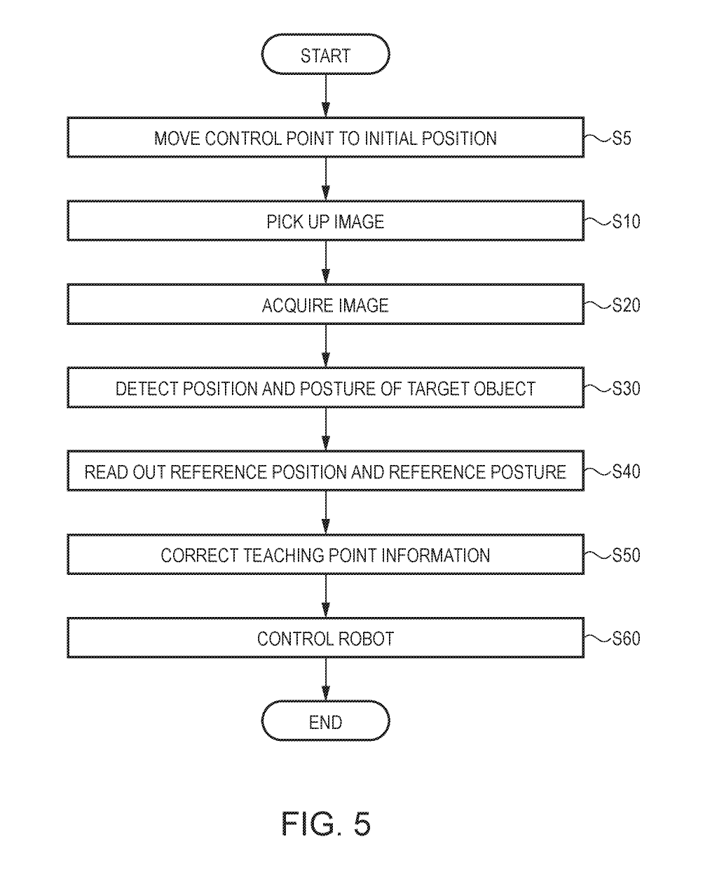

Processing in which the robot control device 30 in the first embodiment causes the robot 20 to perform the first work is explained with reference to FIG. 5. FIG. 5 is a flowchart for explaining an example of a flow of processing in which the robot control device 30 in the first embodiment causes the robot 20 to perform the first work.

The robot control section 47 matches the position and the posture of the control point TC1 with the initial position and the initial posture stored in advance (step S5). Subsequently, the image-pickup control section 40 causes the image pickup section 10 to pickup an image of the image pickup range (step S10). Subsequently, the image acquiring section 41 acquires, from the image pickup section 10, the picked-up image picked up by the image pickup section 10 in step S10 (step S20). Subsequently, the position/posture detecting section 43 detects a detected position and a detected posture according to the pattern matching or the like on the basis of the marker MK included in the picked-up image acquired by the image acquiring section 41 in step S20 (step S30).

Subsequently, the correcting section 44 reads out the reference position and posture information from the storing section 32 (step S40). Subsequently, the correcting section 44 calculates, on the basis of the reference position and posture information read out in step S40, positional deviation and postural deviation between the detected position and the detected posture detected in step S30 and the reference position and the reference posture indicated by the reference position and posture information. The correcting section 44 reads out the teaching point information from the storing section 32. The correcting section 44 corrects the read-out teaching point information on the basis of the calculated positional deviation and the calculated postural deviation (step S50). The positional deviation is, for example, a displacement vector representing deviation between the detected position and the reference position. The postural deviation is, for example, an angle vector having, as components, respective Euler's angles representing deviation between the detected posture and the stored posture. The processing in step S50 is explained.

In this example, the correcting section 44 corrects the position information included in the teaching point information by shifting a relative position of a position indicating the teaching point relative to the reference position by an amount of the positional deviation. The correcting section 44 corrects the posture information included in the teaching point information by shifting a relative posture of the posture of the control point TC1 in the position of the teaching point relative to the reference posture by an amount of the postural deviation. More specifically, in this example, since the position indicated by the position information is the position of the teaching point in the first target object coordinate system, the correcting section 44 corrects the teaching point information by performing coordinate conversion for shifting the position of the origin of the first target object coordinate system on the basis of the positional deviation and performing coordinate conversion for shifting the posture of the first target object coordinate system on the basis of the postural deviation. Consequently, even when positional deviation between the detected position and the stored position occurs, the robot control device 30 can easily suppress accuracy of the first work from being deteriorated.

Subsequently, the robot control section 47 operates the robot 20 on the basis of the teaching point information corrected (subjected to the coordinate conversion) in step S50 and causes the robot 20 to perform the first work (step S60). In this case, the robot control section 47 causes the robot 20 to perform the first work according to the position control based on the teaching point information and control based on the force detection information acquired by the force-detection-information acquiring section 42.

As explained above, the robot control device 30 detects the position and the posture of the target object O1 as the detected position and the detected posture and moves the arm A on the basis of the detected position and the detected posture detected by robot control device 30 and the reference position and the reference posture stored by the storing section 32. Consequently, even when positional deviation between the detected position and the reference position and postural deviation between the detected posture and the reference posture occur, the robot control device 30 can suppress accuracy of the first work from being deteriorated. Note that, instead of this, the robot control device 30 may detect the position of the target object O1 as the detected position and move the arm A on the basis of the detected position detected by the robot control device 30 and the reference position stored by the storing section 32. In this case, even when positional deviation between the detected position and the reference position occurs in the first work, the robot control device 30 can suppress accuracy of the first work from being deteriorated. However, in this case, for example, in griping the target object O1, the robot 20 grips the target object O1 using a jig with which relative postures of the posture of the control point TC1 and the posture of the marker MK are always substantially the same postures.

Processing in which the Robot Control Device Stores the Reference Position and Posture Information and the Teaching Point Information

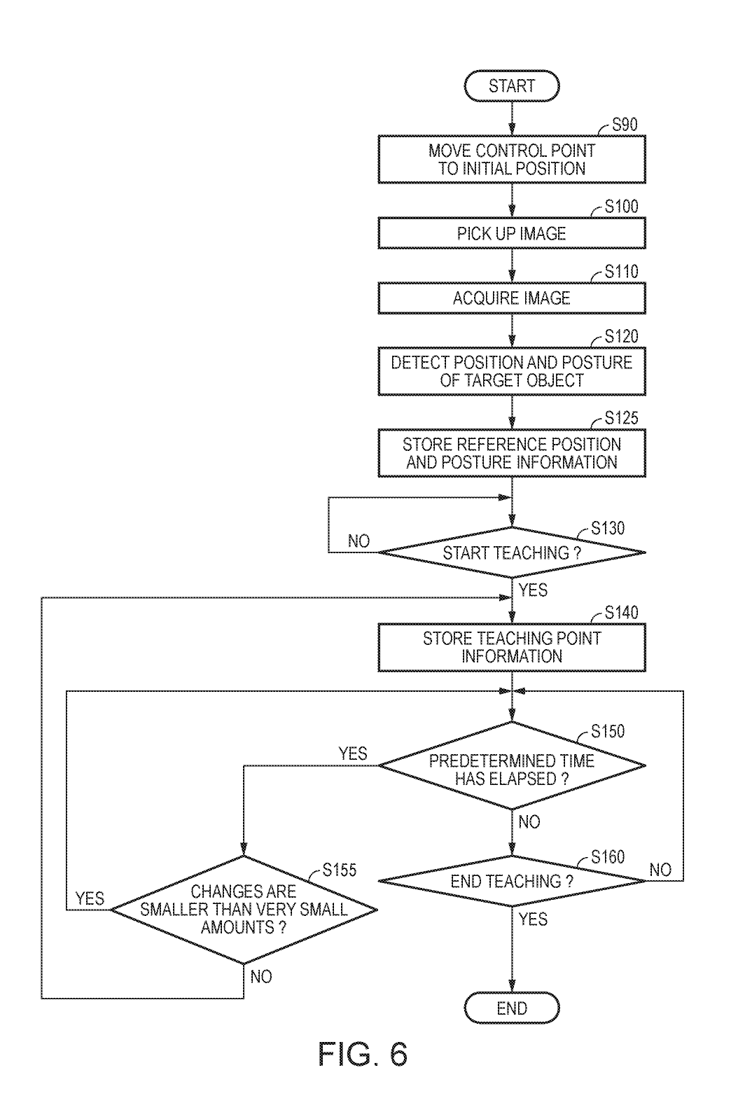

Processing in which the robot control device 30 in the first embodiment stores the reference position and posture information and the teaching point information is explained below with reference to FIG. 6. FIG. 6 is a flowchart for explaining an example of a flow of the processing in which the robot control device 30 in the first embodiment stores the reference position and posture information and the teaching point information. Note that the processing of the flowchart shown in FIG. 6 is processing performed after an operation mode of the robot control device 30 is switched to an operation mode for performing the teaching by the direct teaching. The user performs the switching of the operation mode of the robot control device 30 via the input receiving section 33 on the basis of, for example, a control screen of the robot control device 30 displayed on the display section 35.

After the operation mode of the robot control device 30 is switched to the operation mode for performing the teaching by the direct teaching, the robot control section 47 matches the position and the posture of the control point TC1 with the initial position and the initial posture stored in advance (step S90). Subsequently, the image-pickup control section 40 causes the image pickup section 10 to pick up an image of the image pickup range (step S100). Subsequently, the image acquiring section 41 acquires the picked-up image picked up by the image pickup section 10 in step S100 from the image pickup section 10 (step S110). Subsequently, the position/posture detecting section 43 detects a detected position and a detected posture through the pattern matching or the like on the basis of the marker MK included in the picked-up image acquired by the image acquiring section 41 in step S110 (step S120).

Subsequently, the position/posture detecting section 43 causes, on the basis of the detected position and the detected posture detected in step S120, the storing section 32 to store, as a first target object coordinate system, a three-dimensional local coordinate system, the position of the origin of which is the detected position, having a coordinate axis representing the detected posture in the origin and store information indicating the first target object coordinate system as reference position and posture information (step S125). The robot control section 47 matches the position and the posture of the control point TC1 with a predetermined teaching start position and a predetermined teaching start posture. The teaching start position may be any position as long as the position is a position to which the control point TC1 is movable. However, for example, when it is desired to cause the robot 20 to perform the first work at earlier time, the teaching start position is desirably a position near the tool T1. In this example, the position near the tool T1 is a position within a radius of 50 centimeters centering on the position of the tool T1. Note that, instead of the position, the position near the tool T1 may be another position. The teaching start posture may be any posture as long as the posture is a posture to which the control point TC1 is changeable.

Subsequently, the teaching control section 46 stays on standby until the teaching control section 46 receives operation for performing starting of the teaching by the direct teaching (step S130). In this example, the operation is operation for applying a force equal to or larger than a predetermined threshold to the end effector E toward a predetermined direction. The predetermined direction is, for example, a direction in which a force is not applied to the end effector E in the first work. In this example, the direction is the negative direction of a Z axis in the control point coordinate system TC. Note that the force detecting section 21 or the force-detection-information acquiring section 42 is adjusted to reduce a force included in force detection information at the time when the operation for performing the starting of the teaching by the direct teaching, that is, the gravity applied to the end effector E to zero.

That is, when a positive direction of the Z axis in the control point coordinate system TC of the end effector E faces the vertical downward direction, the user can start the teaching by the direct teaching by pushing the end effector E upward. As a result, the user does not need to move away from the vicinity of the end effector E every time the user starts the teaching by the direct teaching. It is possible to improve efficiency of work for teaching the robot control device 30 about a motion of the robot 20.

Note that, instead of the direction in which a force is not applied to the end effector E in the first work, the predetermined direction may be a direction in which a force is applied to the end effector E in the first work. In this case, the predetermined threshold needs to be set to a force larger than the force applied to the end effector E toward the direction in the first work. The operation for performing the starting of the teaching by the direct teaching may be another kind of operation for, for example, depressing the teaching pendant or a button for performing the starting of the teaching by the direct teaching included in the robot control device 30 instead of applying the force equal to or larger than the predetermined threshold to the end effector E toward the predetermined direction. The button may be a software button or may be a hardware button.

When the position/posture detecting section 43 determines in step S130 that the operation for performing the starting of the teaching by the direct teaching is received (YES in step S130), the teaching control section 46 causes the storing section 32 to store teaching point information in which position information indicating a relative position of position information indicating the position of the end effector E in the robot coordinate system at the present time relative to the reference position indicated by the reference position and posture information stored in the storing section 32, posture information indicating a relative posture of the posture of the end effector E in the robot coordinate system at the present time relative to the reference posture indicated by the reference position and posture information stored in the storing section 32, and information indicating the present time (order information in this example) are associated with one another (step S140).

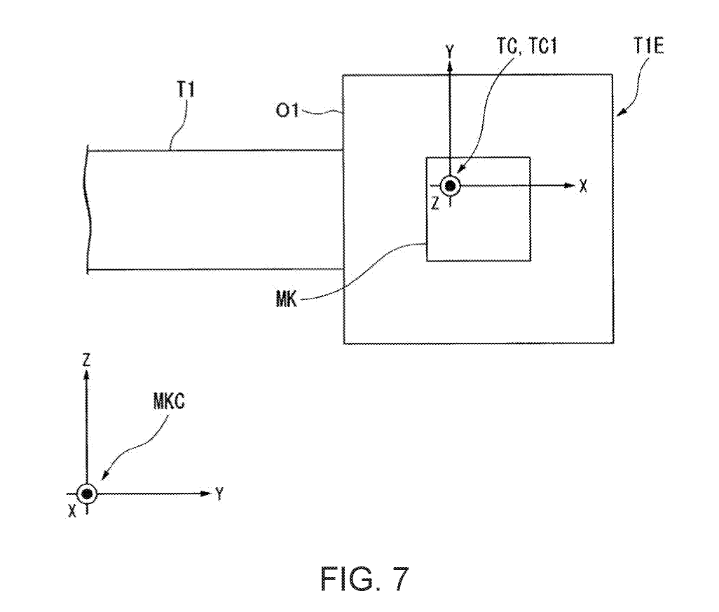

The processing in step S140 is explained with reference to FIG. 7. FIG. 7 is a diagram showing an example of a state in which the target object O1 and the work part T1E are set in contact according to the teaching by the direct teaching after the processing in step S140 is started. A view shown in FIG. 7 is a view of the target object O1 viewed toward the negative direction of the Z axis in the control point coordinate system TC. As shown in FIG. 7, in the teaching by the direct teaching, the user changes the position and the posture of the end effector E (i.e., the control point TC1) in a first target object coordinate system MKC such that a portion in contact with the work part T1E in the outer peripheral portion of the target object O1 turns around from a start point portion along the outer peripheral section. In FIG. 7, the posture of the end effector E is represented by directions in which the respective coordinate axes of the control point coordinate system TC face in the first target object coordinate system MKC.

In the teaching by the direct teaching, while the user is changing the position and the posture of the end effector E such that the portion in contact with the work part T1E in the outer peripheral portion of the target object O1 turns around the outer peripheral portion from the start point portion, every time a predetermined time elapses, the teaching control section 46 causes the storing section 32 to store the teaching point information in which the position information indicating the relative position of the position information indicating the position of the end effector E at the present time relative to the reference position indicated by the reference position and posture information stored in the storing section 32, the posture information indicating the relative posture of the posture of the end effector E at the present time relative to the reference posture indicated by the reference position and posture information stored in the storing section 32, and the information indicating the present time (the order information in this example) are associated with one another.

The teaching point information is teaching point information corresponding to the present position and the present posture of the end effector E and the relative position and the relative posture relative to the reference position and the reference posture. Therefore, by correcting the teaching point information on the basis of positional deviation and postural deviation between the detected position and the detected posture and the reference position and the reference posture in step S50 shown in FIG. 5, the robot control device can suppress accuracy of the first work from being deteriorated.

Even when the predetermined time elapses, when both of a difference between the relative position of the present position of the end effector E relative to the reference position and a position indicated by position information included in teaching point information stored immediately before and a difference between a relative posture of the present posture of the end effector E relative to the reference posture and a posture indicated by posture information included in the teaching point information stored immediately before are very small amounts, the teaching control section 46 stays on standby until the predetermined time elapses again without causing the storing section 32 to store the teaching point information. Consequently, the robot control device 30 can suppress the robot control device 30 from causing the robot 20 to perform an unintended motion such as an unintended stop of the movement of the end effector E. Note that, even when both of the differences are very small amounts, the teaching control section 46 may cause the storing section 32 to store the teaching point information every time the predetermined time elapses.

For example, when the a norm of vectors representing the difference between the relative position of the present position of the end effector E relative to the reference position and the position indicated by the position information included in the teaching point information stored immediately before is smaller than one millimeter, the teaching control section 46 determines that the difference is a very small amount. For example, when a norm of vectors having, as components, respective Euler's angles representing the difference between the relative posture of the present posture of the end effector E relative to the reference posture and the posture indicated by the posture information included in the teaching point information stored immediately before is smaller than 1°, the teaching control section 46 determines that the difference is a very small amount.

In this example, the teaching control section 46 calculates the present position and the present posture of the end effector E (i.e., the control point TC1) on the basis of kinematics by acquiring rotation angles of the actuators included in the manipulator M from encoders respectively included in the actuators. The teaching control section 46 determines, according to the clocking by the clocking section 45, whether the predetermined time has elapsed.

After the teaching point information is stored in step S140, the teaching control section 46 determines, on the basis of the clocking by the clocking section 45, whether the predetermined time has elapsed (step S150). When determining that the predetermined time has elapsed (YES in step S150), the teaching control section 46 determines whether both of the difference between the relative position of the present position of the end effector E relative to the reference position and the position indicated by the position information included in the teaching point information stored immediately before and the difference between the relative posture of the present posture of the end effector E relative to the reference posture and the posture indicated by the posture information included in the teaching point information stored immediately before are very small amounts (step S155).

When determining that both of the differences are very small amounts (YES in step S155), the teaching control section 46 transitions to step S150 and determines whether the predetermined time has elapsed again. On the other hand, when determining that both of the differences are not very small amounts (NO in step S155), the teaching control section 46 transitions to step S140 and causes the storing section 32 to store the teaching point information again. Note that, even when both of the differences are very small amounts, the teaching control section 46 may cause the storing section 32 to store the teaching point information every time the predetermined time elapses. In this case, the teaching control section 46 omits the processing in step S155 and, after determining YES in step S150, transitions to step S140.

On the other hand, when determining in step S150 that the predetermined time has not elapsed (NO in step S150), the teaching control section 46 determines whether operation for performing ending of the teaching by the direct teaching is received (step S160). When determining that the operation for performing the ending of the teaching by the direct teaching is not received (NO in step S160), the teaching control section transitions to step S150 and determines whether the predetermined time has elapsed again.

On the other hand, when the teaching control section 46 determines that the operation for performing the ending of the teaching by the direct teaching is received (YES in step S160), the control section 36 ends the processing. In this example, the operation is operation for applying a force equal to or larger than a predetermined threshold to the end effector E toward a predetermined direction. The predetermined direction is, for example, a direction in which a force is not applied to the end effector E in the first work. In this example, the direction is the negative direction of the Z axis in the control point coordinate system TC. Note that the force detecting section 21 or the force-detection-information acquiring section 42 is adjusted to reduce a force included in force detection information in performing the operation for performing the ending of the teaching by the direct teaching, that is, the gravity applied to the end effector E to zero.

For example, when the positive direction of the Z axis in the control point coordinate system TC of the end effector E faces the vertical downward direction, the user can end the teaching by the direct teaching by pressing the end effector E upward. As a result, the user does not need to move away from the vicinity of the end effector E every time the user ends the teaching by the direct teaching. It is possible to improve efficiency of work for teaching the robot control device 30 about a motion of the robot 20.

Note that the predetermined direction may be a direction in which a force is applied to the end effector E in the first work instead of the direction in which a force is not applied to the end effector E in the first work. In this case, the predetermined threshold needs to be set to a force larger than the force applied to the end effector E toward the direction in the first work. The operation for performing the ending of the teaching by the direct teaching may be another kind of operation for, for example, depressing a button for performing the ending of the teaching by the direct teaching included in the teaching pendant or the robot control device 30 instead of the operation for applying the force equal to or larger than the predetermined threshold to the end effector E toward the predetermined direction. The button may be a software button or may be a hardware button.

As explained above, the robot control device 30 stores the reference position and posture information and the teaching point information in the storing section 32. Note that, when the teaching by the direct teaching is performed, the tool T1 may be replaced with another object capable of bringing a part of the outer peripheral portion of the target object O1 into contact with a position same as the position of the work part T1E. By performing such replacement, it is possible to suppress the target object O1 from being shaved by the polishing belt of the tool T1 when the teaching by the direct teaching is performed. In this example, the robot 20 performs the polishing of the target object O1 as the first work using the tool T1. However, instead of this, the robot 20 may perform work such as bonding, painting, welding, assembly, or inspection of the target object O1 as the first work using another tool.

### Second Embodiment

A second embodiment of the invention is explained below with reference to the drawings. Note that the configuration of the robot 20 in the second embodiment is the same as the configuration of the robot 20 in the first embodiment. Therefore, explanation of the configuration is omitted.

### Overview of Predetermined Work Performed by the Robot

An overview of second work, which is predetermined work, performed by the robot 20 in the second embodiment is explained.

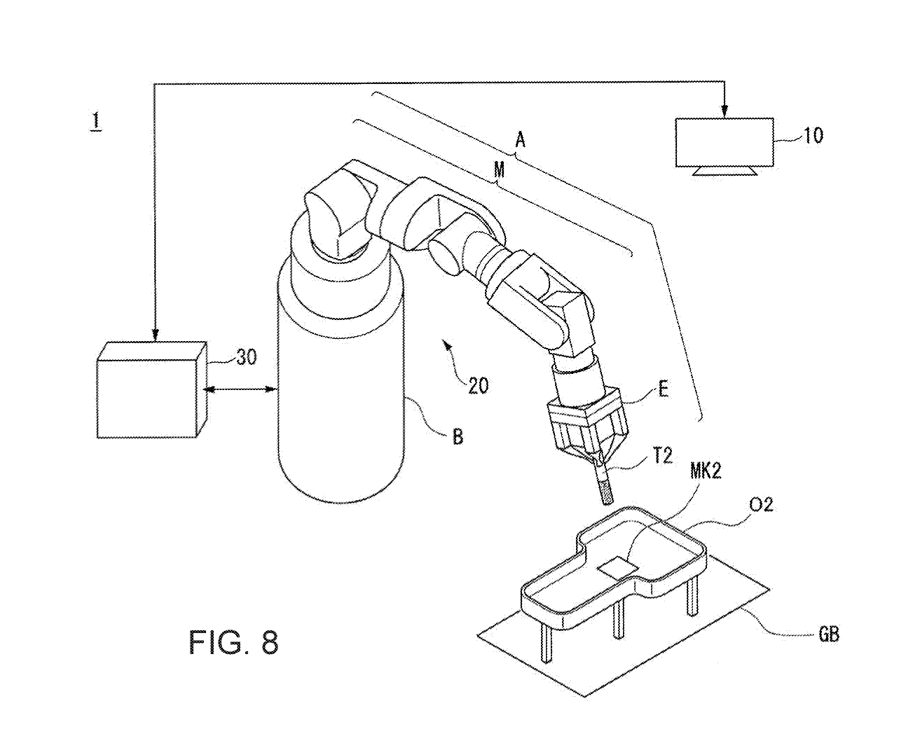

FIG. 8 is a diagram showing an example of the configuration of the robot system 1 according to the second embodiment. In FIG. 8, unlike the robot 20 in the first embodiment, the robot 20 in the second embodiment grips a tool T2 in advance with the end effector E. Note that the robot 20 may grip the tool T2 disposed in a predetermined tool house without gripping the tool T2 in advance.

In this example, the tool T2 is a polishing device having a cylinder shape. In the tool T2, a file is provided on a side surface at an end portion on the opposite side of the end effector E side at an end portion of the cylinder. The tool T2 can rotate, with the center axis of the cylinder set as a rotation axis, a polishing section, which is a portion provided with the file. Note that the tool T2 may be another tool such as a discharging device that discharges an adhesive. The shape of the tool T2 may be another shape instead of the cylinder shape.

As the second work, the robot 20 moves the tool T2 with the end effector E and polishes a target object O2 with the tool T2. The target object O2 is, for example, an industrial component, member, or product. In the following explanation, as an example, the target object O2 is a T flat-shape component. Corners of the target object O2 at the time when the target object O2 is viewed in the direction of surfaces of the flat shape are rounded.

An outer peripheral portion, which is a portion of the outer periphery in one surface of the surfaces is large in height in a direction opposite to a direction from the surface to the rear surface of the surface compared with a portion different from the portion of the surface. Note that, instead of the component, the target object O2 may be another object such as another component, member, or product different from the industrial one or an organism. The shape of the target object O2 may be another shape instead of the T flat shape. In this example, the target object O2 is fixed to, to prevent the position and the posture of the target object O2 in a robot coordinate system from changing, a jig GB set on a table, a floor surface, or the like in a region where the robot 20 is capable of performing work.

A marker MK2 is provided on the surface on which the outer peripheral portion is formed of the surfaces of the target object O2. The marker MK2 is a mark indicating a second target object coordinate system, which is a three-dimensional local coordinate system representing the position and the posture of the target object O2. The position and the posture of the target object O2 are the position and the posture of the target object O2 in the robot coordinate system. The position of the origin of the second target object coordinate system represents, for example, as the position of the target object O2, the position of the center of gravity of the target object O2. The directions of respective coordinate axes of the second target object coordinate system represent the posture of the target object O2.

Note that the marker MK2 may be any mark as long as the mark is a mark that can indicate the second target object coordinate system. The marker MK2 may be a part of the target object O2.

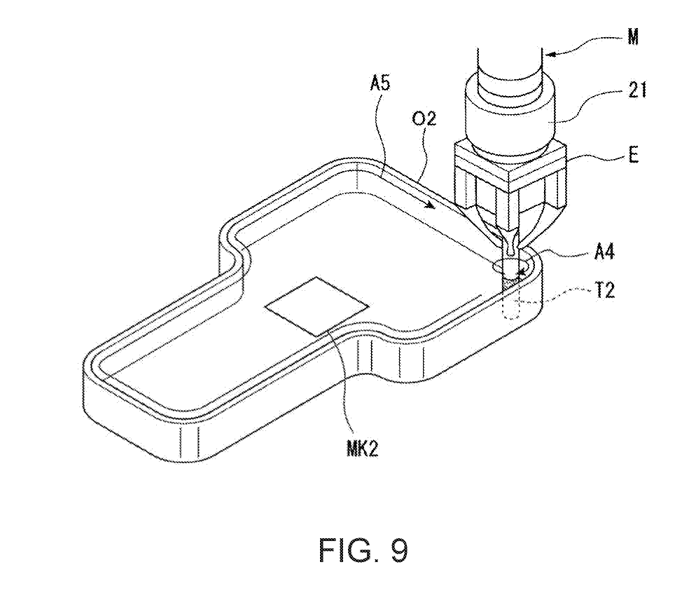

The robot 20 polishes the inner peripheral surface of the target object O2 using the tool T2. The inner peripheral surface of the target object O2 is a surface on a region side surrounded by the outer peripheral portion of the surfaces of the outer peripheral portion. Operation of the robot 20 for polishing the inner peripheral surface of the target object O2 using the tool T2 in the second embodiment is explained with reference to FIG. 9. Note that the robot 20 may polish the outer peripheral surface of the target object O2 using the tool T2. FIG. 9 is a diagram showing an example of a state in which the robot 20 is polishing the inner peripheral surface of the target object O2 using the tool T2.

In the example shown in FIG. 9, a polishing section of the tool T2 is rotating in a direction A4, which is a direction indicated by an arrow shown in FIG. 9. The robot 20 polishes the inner peripheral surface by bringing the polishing section of the tool T2 gripped by the end effector E into contact with the inner peripheral surface of the target object O2. In this example, the robot 20 brings the polishing section of the tool T2 into contact with a part of the inner peripheral surface. The robot 20 changes the position and the posture of the control point TC1 such that a portion of the inner peripheral surface in contact with the polishing section turns around from the part along the inner peripheral surface. That is, the part is a start point portion, which is a portion serving as a start point where the inner peripheral surface starts to be polished. In this way, as the second work, the robot 20 polishes the inner peripheral surface of the target object O2 with the tool T2.

When the robot 20 polishes the inner peripheral surface of the target object O2 with the tool T2 in the second work, the robot control device 30 reads out teaching point information stored in advance. The robot control device 30 causes the robot 20 to polish the inner peripheral surface of the target object O2 with the tool T2 by moving the arm A according to the position control on the basis of the read-out teaching point information to thereby change the position and the posture of the control point TC1, that is, the position and the posture of the end effector E. A reference position in this example is the position of the target object O2, that is, the position of the marker MK2 at the time when the teaching by the direct teaching is performed in order to cause the robot control device 30 to store the teaching point information. A reference posture in this example is the posture of the target object O2, that is, the posture of the marker MK2 at the time when the teaching by the direct teaching is performed in order to cause the robot control device 30 to store the teaching point information.

When a relative position and a relative posture of the position and the posture of the marker MK2 relative to the reference position and the reference posture do not always change and are fixed, the robot control device 30 can cause the robot 20 to polish the inner peripheral surface of the target object O2 with the tool T2 by moving the arm A according to the position control on the basis of the read-out teaching point information to thereby change the position and the posture of the control point TC1, that is, the position and the posture of the end effector E.

However, actually, depending on an error or the like in setting the target object O2 in the jig GB, the relative position and the relative posture of the position and the posture of the marker MK2 during the second work relative to the reference position and the reference posture are not always fixed. If the relative position and the relative posture change, when the robot control device 30 moves the robot 20 on the basis of the teaching point information stored in advance, accuracy of the second work by the robot 20 is deteriorated.

Therefore, the robot control device 30 in this example performs image pickup with the image pickup section 10 with an image pickup range set in a range including the marker MK2 provided in the target object O2. The robot control device 30 detects the position and the posture of the target object O2 on the basis of the marker MK2 included in a picked-up image. The robot control device 30 calculates positional deviation, which is deviation between the detected position, which is the position detected by the detecting section, and the reference position stored in advance and calculates postural deviation, which is deviation between a detected posture, which is the posture detected by the detecting section, and the reference posture stored in advance.

The robot control device 30 corrects the read teaching point information on the basis of the calculated positional deviation and the calculated postural deviation, moves the arm A on the basis of the corrected teaching point information, and causes the robot 20 to perform the second work. Consequently, in the second work, even when positional deviation between the detected position and the reference position and postural deviation between the detected posture and the reference posture occur, the robot control device 30 can suppress accuracy of the second work from being deteriorated.

When turning around, from the start point portion along the inner peripheral surface, the portion where the polishing section of the tool T2 is in contact with the inner peripheral surface of the target object O2 during the second work, the robot control device 30 rotates, according to the position control and control based on the force detection information acquired from the force detecting section 21, the control point TC1 in a direction A5, which is a direction indicated by an arrow shown in FIG. 9, while keeping a state in which the tool T2 and the inner peripheral surface are in contact.

In this example, the direction A4 and the direction A5 are respectively directions along the XY plane in the robot coordinate system. Therefore, when some part of the inner peripheral surface of the target object O2 is in contact with the polishing section of the tool T2, the force detecting section 21 detects at least one of a force toward a direction along the X axis in the control point coordinate system TC and a force toward a direction along the Y axis in the control point coordinate system TC. Note that the robot control device 30 may cause the robot 20 to polish the inner peripheral surface of the target object O2 with the tool T2 according to only the position control.

In the following explanation, processing in which the robot control device 30 moves the arm A on the basis of the detected position and the detected posture and the reference position and the reference posture in causing the robot 20 to perform the second work is explained in detail. Note that, instead of detecting the position and the posture of the target object O2 in the robot coordinate system on the basis of (the marker MK2 included in) a picked-up image picked up by the image pickup section 10, the robot control device 30 may detect the position and the posture with another means such as a sensor that detects the position and the posture with a laser, an infrared ray, or the like.

In the following explanation, processing in which the robot control device 30 stores the reference position, the reference posture, and the teaching point information is explained. In this example, the processing in which the robot control device 30 stores the teaching point information is performed according to the teaching by the direct teaching. Note that the robot control device 30 may store the teaching point information according to another method such as teaching by online teaching instead of storing the teaching point information according to the teaching by the direct teaching.

### Hardware Configuration and Functional Configuration of the Robot Control Device

A hardware configuration and a functional configuration of the robot control device 30 in the second embodiment are the same as the hardware configuration and the functional configuration of the robot control device 30 in the first embodiment. Therefore, explanation of the hardware configuration and the functional configuration is omitted. However, the position/posture detecting section 43 detects, on the basis of a picked-up image acquired by the image acquiring section 41, the position and the posture of the target object O2 in the robot coordinate system as the detected position and the detected posture.

Processing in which the Robot Control Device Causes the Robot to Perform the Second Work

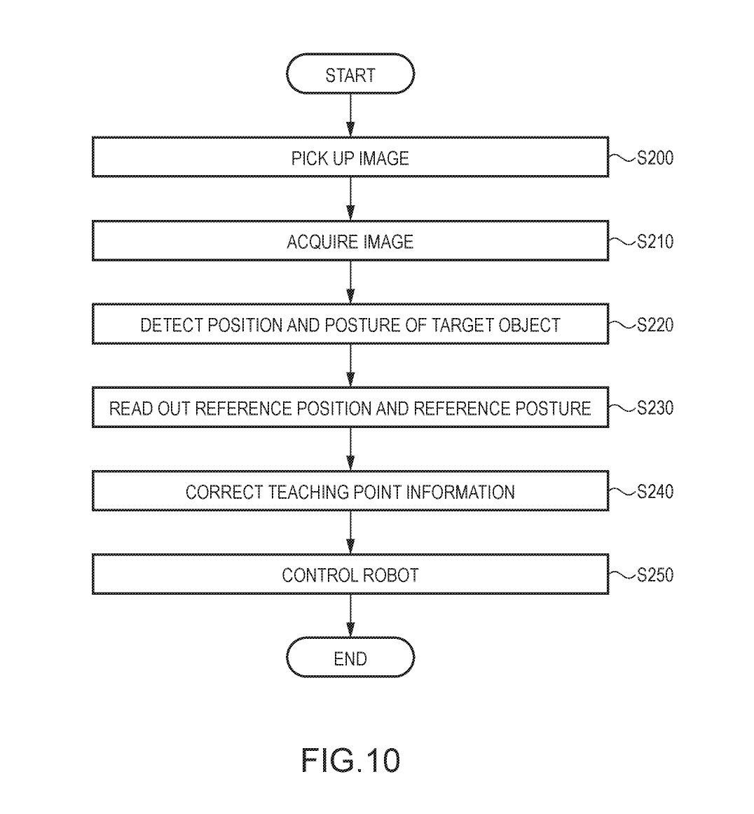

Processing in which the robot control device 30 in the second embodiment causes the robot 20 to perform the second work is explained below with reference to FIG. 10. FIG. 10 is a flowchart for explaining an example of a flow of the processing in which the robot control device 30 in the second embodiment causes the robot 20 to perform the second work.

The image-pickup control section 40 causes the image pickup section 10 to pick up an image of the image pickup range (step S200). The robot control section 47 in this example may or may not match the position and the posture of the control point TC1 with an initial position and an initial posture stored in advance before the processing in step S200 is performed. Subsequently, the image acquiring section 41 acquires, from the image pickup section 10, the picked-up image picked up by the image pickup section 10 in step S200 (step S210). Subsequently, the position/posture detecting section 43 detects, on the basis of the marker MK2 included in the picked-up image acquired by the image acquiring section 41 in step S210, a detected position and a detected posture according to pattern matching or the like (step S220).

Subsequently, the correcting section 44 reads out the reference position and posture information from the storing section 32 (step S230). Subsequently, the correcting section 44 calculates, on the basis of the reference position and posture information readout in step S230, positional deviation and postural deviation between the detected position and the detected posture detected in step S220 and the reference position and the reference posture indicated by the reference position and posture information. The correcting section 44 reads out the teaching point information from the storing section 32. The correcting section 44 corrects the read-out teaching point information on the basis of the calculated positional deviation and the calculated postural deviation (step S240). The processing in step S240 is the same as processing in which the first target object coordinate system in the processing in step S50 shown in FIG. 5 is replaced with the second target object coordinate system. Therefore, explanation of the processing is omitted.

Subsequently, the robot control section 47 operates the robot 20 on the basis of the teaching point information corrected (subjected to the coordinate conversion) in step S240 and causes the robot 20 to perform the second work (step S250). In this case, the robot control section 47 causes the robot 20 to perform the second work according to the position control based on the teaching point information and control based on the force detection information acquired by the force-detection-information acquiring section 42.

As explained above, the robot control device 30 detects the position and the posture of the target object O2 as the detected position and the detected posture and moves the arm A on the basis of the detected position and the detected posture detected by robot control device 30 and the reference position and the reference posture stored by the storing section 32. Consequently, even when positional deviation between the detected position and the reference position and postural deviation between the detected posture and the reference posture occur, the robot control device 30 can suppress accuracy of the second work from being deteriorated. Note that, instead of this, the robot control device 30 may detect the position of the target object O2 as the detected position and move the arm A on the basis of the detected position detected by the robot control device 30 and the reference position stored by the storing section 32. In this case, even when positional deviation between the detected position and the reference position occurs in the second work, the robot control device 30 can suppress accuracy of the second work from being deteriorated. However, in this case, for example, in setting the target object O2 in the jig GB, the user sets the target object O2 in the jig GB with which a relative posture of the posture of the marker MK2 relative to the reference posture is always substantially the same posture.

Processing in which the Robot Control Device Stores the Reference Position and Posture Information and the Teaching Point Information

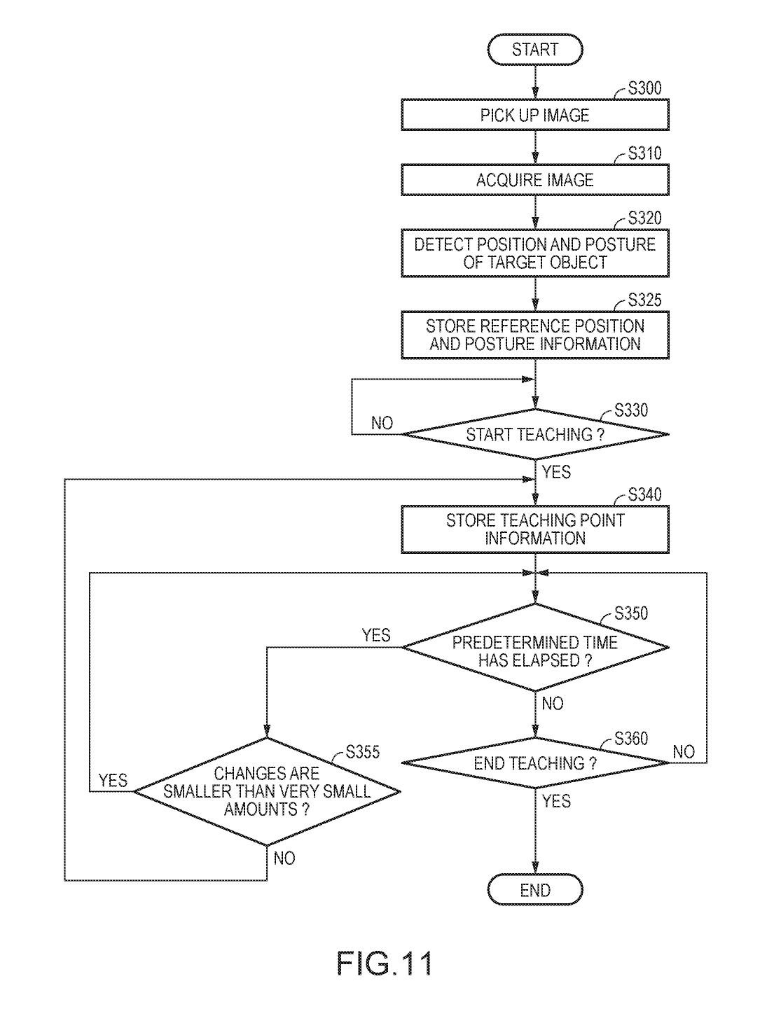

Processing in which the robot control device 30 in the second embodiment stores the reference position and posture information and the teaching point information is explained below with reference to FIG. 11. FIG. 11 is a flowchart for explaining an example of a flow of the processing in which the robot control device 30 in the second embodiment stores the reference position and posture information and the teaching point information. Note that the processing of the flowchart shown in FIG. 11 is processing performed after an operation mode of the robot control device 30 is switched to an operation mode for performing the teaching by the direct teaching. The user performs the switching of the operation mode of the robot control device 30 via the input receiving section 33 on the basis of, for example, a control screen of the robot control device 30 displayed on the display section 35.

After the operation mode of the robot control device 30 is switched to the operation mode for performing the teaching by the direct teaching, the image-pickup control section 40 causes the image pickup section 10 to pick up an image of the image pickup range (step S300). Before the processing in step S300 is performed, the robot control section 47 in this example may or may not match the position and the posture of the control point TC1 with the initial position and the initial posture stored in advance.

Subsequently, the image acquiring section 41 acquires the picked-up image picked up by the image pickup section 10 in step S300 from the image pickup section 10 (step S310). Subsequently, the position/posture detecting section 43 detects a detected position and a detected posture through the pattern matching or the like on the basis of the marker MK2 included in the picked-up image acquired by the image acquiring section 41 in step S310 (step S320).

Subsequently, the position/posture detecting section 43 causes, on the basis of the detected position and the detected posture detected in step S320, the storing section 32 to store, as a second target object coordinate system, a three-dimensional local coordinate system, the position of the origin of which is the detected position, having a coordinate axis representing the detected posture in the origin and store information indicating the second target object coordinate system as reference position and posture information (step S325). The robot control section 47 matches the position and the posture of the control point TC1 with a predetermined teaching start position and a predetermined teaching start posture.

Subsequently, the teaching control section 46 stays on standby until the teaching control section 46 receives operation for performing starting of the teaching by the direct teaching (step S330). Subsequently, when the position/posture detecting section 43 determines that the operation for performing the starting of the teaching by the direct teaching is received (YES in step S330), the teaching control section 46 causes the storing section 32 to store teaching point information in which position information indicating a relative position of position information indicating the position of the end effector E in the robot coordinate system at the present time relative to the reference position indicated by the reference position and posture information stored in the storing section 32, posture information indicating a relative posture of the posture of the end effector E in the robot coordinate system at the present time relative to the reference posture indicated by the reference position and posture information stored in the storing section 32, and information indicating the present time (order information in this example) are associated with one another (step S340).

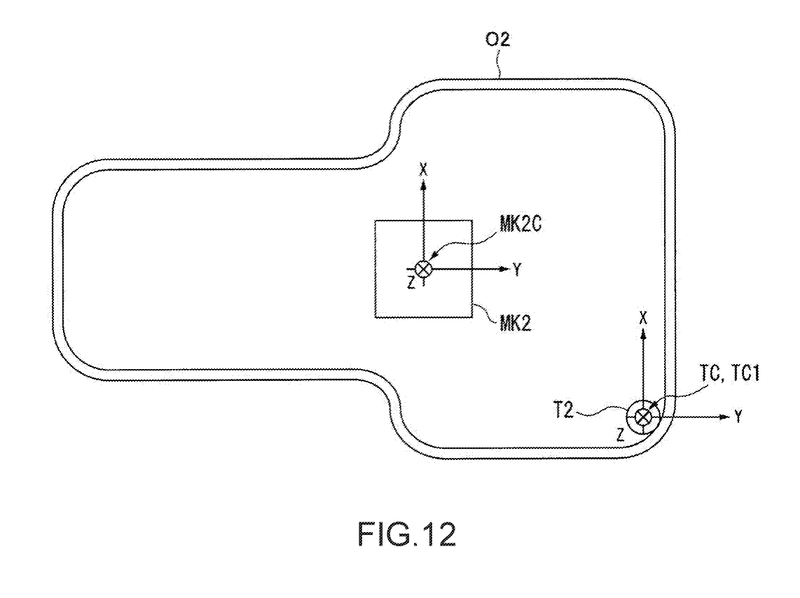

The processing in step S340 is explained with reference to FIG. 12. FIG. 12 is a diagram showing an example of a state in which the target object O2 and the polishing section of the tool T2 are set in contact according to the teaching by the direct teaching after the processing in step S340 is started. A view shown in FIG. 12 is a view of the target object O2 viewed toward the negative direction of the Z axis in the control point coordinate system TC. As shown in FIG. 12, in the teaching by the direct teaching, the user changes the position and the posture of the end effector E (i.e., the control point TC1) in a second target object coordinate system MK2C such that a portion in contact with the polishing section of the tool T2 in the inner peripheral surface of the target object O2 turns around from a start point portion along the inner peripheral surface. In FIG. 12, the posture of the end effector E is represented by relative directions of the respective coordinate axes of the control point coordinate system TC relative to the directions of the respective coordinate axes of the second target object coordinate system MK2C.

In the teaching by the direct teaching, while the user is changing the position and the posture of the end effector E such that the portion in contact with the polishing section of the tool T2 in the inner peripheral surface of the target object O2 turns around from the start point portion along the inner peripheral surface, every time a predetermined time elapses, the teaching control section 46 causes the storing section 32 to store the teaching point information in which the position information indicating the relative position of the position information indicating the position of the end effector E at the present time relative to the reference position indicated by the reference position and posture information stored in the storing section 32, the posture information indicating the relative posture of the posture of the end effector E at the present time relative to the reference posture indicated by the reference position and posture information stored in the storing section 32, and the information indicating the present time (the order information in this example) are associated with one another.

Even when the predetermined time elapses, when both of a difference between the relative position of the present position of the end effector E relative to the reference position and a position indicated by position information included in teaching point information stored immediately before and a difference between the relative posture of the present posture of the end effector E relative to the reference posture and a posture indicated by posture information included in the teaching point information stored immediately before are very small amounts, the teaching control section 46 stays on standby until the predetermined time elapses again without causing the storing section 32 to store the teaching point information. Consequently, the robot control device 30 can be suppressed from causing the robot 20 to perform an unintended motion such as an unintended stop of the movement of the end effector E.

After the teaching point information is stored in step S340, the teaching control section 46 determines, on the basis of the clocking by the clocking section 45, whether the predetermined time has elapsed (step S350). When determining that the predetermined time has elapsed (YES in step S350), the teaching control section 46 determines whether both of the difference between the relative position of the present position of the end effector E relative to the reference position and the position indicated by the position information included in the teaching point information stored immediately before and the difference between the relative posture of the present posture of the end effector E relative to the reference posture and the posture indicated by the posture information included in the teaching point information stored immediately before are very small amounts (step S355).

When determining that both of the differences are very small amounts (YES in step S355), the teaching control section 46 transitions to step S350 and determines whether the predetermined time has elapsed again. On the other hand, when determining that both of the differences are not very small amounts (NO in step S355), the teaching control section 46 transitions to step S340 and causes the storing section 32 to store the teaching point information again. Note that, even when both of the differences are very small amounts, the teaching control section 46 may cause the storing section 32 to store the teaching point information every time the predetermined time elapses. In this case, the teaching control section 46 omits the processing in step S355 and, after determining YES in step S350, transitions to step S340.

On the other hand, when determining in step S350 that the predetermined time has not elapsed (NO in step S350), the teaching control section 46 determines whether operation for performing ending of the teaching by the direct teaching is received (step S360). When determining that the operation for performing the ending of the teaching by the direct teaching is not received (NO in step S360), the teaching control section transitions to step S350 and determines whether the predetermined time has elapsed again. On the other hand, when the teaching control section 46 determines that the operation for ending the teaching by the direct teaching is received (YES in step S360), the control section 36 ends the processing.

As explained above, the robot control device 30 stores the reference position and posture information and the teaching point information in the storing section 32. Note that, when the teaching by the direct teaching is performed, the tool T2 may be replaced with another object having a shape same as the shape of the tool T2. By performing such replacement, it is possible to suppress the target object O2 from being shaved by the polishing section of the tool T2 when the teaching by the direct teaching is performed. In this example, the robot 20 performs the polishing of the target object O2 as the second work using the tool T2. However, instead of this, the robot 20 may perform work such as bonding, painting, welding, assembly, or inspection of the target object O2 as the second work using another tool.

As explained above, the robot 20 incorporating the robot control device 30 in the first embodiment and the second embodiment moves the arm (the arm A in the first embodiment and the second embodiment) on the basis of the detected position, which is the position of the target object (the target object O1 in the first embodiment and the target object O2 in the second embodiment) detected by the detecting section (in this example, the image pickup section 10), and the stored position, which is the position of the target object stored by the storing section (the storing section 32 in the first embodiment and the second embodiment). Consequently, even when positional deviation between the detected position and the stored position occurs, the robot 20 can suppress accuracy of work from being deteriorated.

The robot 20 moves the arm on the basis of the detected position and the stored position, which are the positions based on at least one of a part of the target object and the marker (the marker MK in the first embodiment and the marker MK2 in the second embodiment) provided in the target object. Consequently, even when positional deviation occurs between the detected position and the stored position, which are the positions based on at least one of a part of the target object and the marker provided in the target object, the robot 20 can suppress accuracy of work from being deteriorated.

The robot 20 moves the arm on the basis of the detected position detected on the basis of the picked-up image picked up by the image pickup section (the image pickup section 10 in the first embodiment and the second embodiment) and the stored position. Consequently, even when positional deviation between the detected position detected on the basis of the picked-up image picked up by the image pickup section and the stored position occurs, the robot 20 can suppress accuracy of work from being deteriorated.

The robot 20 moves the target object with the arm. Consequently, even when positional deviation between the detected position and the stored position occurs, the robot 20 can suppress accuracy of work for moving the target object with the arm from being deteriorated.

The robot 20 moves the target object with the arm. Consequently, in the robot 20, the teaching point information including the position information, which is the information indicating the position, is stored in the storing section according to the teaching by the direct teaching based on the output of the force detecting section (the force detection information in the first embodiment and the second embodiment). Consequently, the robot 20 can move the arm on the basis of the teaching point information stored according to the teaching by the direct teaching.

In the robot 20, the teaching point information is stored in the storing section every time the predetermined time elapses in the teaching by the direct teaching. Consequently, the robot 20 can move the arm on the basis of the teaching point information stored in the storing section every time the predetermined time elapses in the teaching by the direct teaching.

The robot 20 moves the arm according to the position control for matching the control point, which is the position associated with the arm, with the position indicated by the position information. Consequently, the robot 20 can suppress accuracy of work performed by the position control from being deteriorated.

The robot 20 moves the arm according to the position control and the control based on the output of the force detecting section (the force detecting section 21 in the first embodiment and the second embodiment). Consequently, the robot 20 can suppress accuracy of work performed according to the position control and the control based on the output of the force detecting section from being deteriorated.

The robot 20 performs at least one of the starting of the teaching by the direct teaching and the ending of the teaching by the direct teaching on the basis of the output of the force detecting section. Consequently, the robot 20 can improve efficiency of work.

The robot 20 moves the arm on the basis of the positional deviation between the detected position and the stored position and the teaching point information. Consequently, the robot 20 can suppress, on the basis of the positional deviation between the detected position and the stored position and the teaching point information, accuracy of work from being deteriorated.

The robot 20 corrects the teaching point information on the basis of the positional deviation and moves the arm. Consequently, the robot 20 can suppress, on the basis of the corrected teaching point information, accuracy of work from being deteriorated.

The robot 20 corrects the teaching point information according to the coordinate conversion. Consequently, the robot 20 can suppress, on the basis of the teaching point information corrected according to the coordinate conversion, accuracy of work from being deteriorated.

The robot 20 moves the arm on the basis of the detected posture, which is the posture of the target object detected by the detecting section, and the detected position and the stored posture, which is the posture of the target object stored by the storing section, and the stored position. Consequently, even when positional deviation between the detected position and the stored position and postural deviation between the detected posture and the stored posture occur, the robot 20 can suppress accuracy of work from being deteriorated.

The embodiments of the invention are explained above in detail with reference to the drawings. However, a specific configuration is not limited to the embodiments and may be, for example, changed, substituted, or deleted without departing from the spirit of the invention.

It is also possible to record (store), in a computer-readable recording medium, a computer program for realizing functions of any components in the devices (e.g., the robot control device 30) explained above, cause a computer system to read the computer program, and execute the computer program. Note that the “computer system” includes an operating system (OS) or hardware such as peripheral devices. The “computer-readable recording medium” refers to a portable medium such as a flexible disk, a magneto-optical disk, a ROM, or a CD (Compact Disk)-ROM or a storage device such as a hard disk incorporated in the computer system. Further, the “computer-readable recording medium” includes a recording medium that stores a computer program for a fixed time such as a volatile memory (a RAM) inside a computer system functioning as a server or a client when a computer program is transmitted via a network such as the Internet or a communication line such as a telephone line.

The computer program may be transmitted from a computer system, which stores the computer program in a storage device or the like, to another computer system via a transmission medium or by a transmission wave in the transmission medium. The “transmission medium”, which transmits the computer program, refers to a medium having a function of transmitting information like a network (a communication network) such as the Internet or a communication line (a communication wire) such as a telephone line.

The computer program may be a computer program for realizing a part of the functions explained above. Further, the computer program may be a computer program that can realize the functions in a combination with a computer program already recorded in the computer system, a so-called differential file (a differential program).

The entire disclosure of Japanese Patent Application No. 2016-005019, filed Jan. 14, 2016 is expressly incorporated by reference herein.

What is claimed is:

1. A robot comprising an arm, wherein
the robot moves the arm on the basis of a detected position, which is a position of a target object detected by a detecting section, and a stored position, which is a position of the target object stored by a storing section.

2. The robot according to claim 1, wherein the detected position and the stored position are positions based on at least one of a part of the target object and a marker provided in the target object.

3. The robot according to claim 1, wherein
the detecting section is an image pickup section, and
the detected position is detected on the basis of a picked-up image picked up by the image pickup section.

4. The robot according to claim 1, wherein the robot moves the target object with the arm.

5. The robot according to claim 1, further comprising a force detecting section configured to detect a force, wherein
teaching point information including position information, which is information indicating a position, is stored in the storing section according to teaching by direct teaching based on an output of the force detecting section.

6. The robot according to claim 5, wherein the teaching point information is stored in the storing section every time a predetermined time elapses in the teaching.

7. The robot according to claim 5, wherein the robot moves the arm according to position control for matching a control point, which is a position associated with the arm, with the position indicated by the position information.

8. The robot according to claim 7, wherein the robot moves the arm according to the position control and control based on the output of the force detecting section.

9. The robot according to claim 5, wherein the robot performs at least one of starting of the teaching and ending of the teaching on the basis of the output of the force detecting section.

10. The robot according to claim 5, wherein the robot moves the arm on the basis of positional deviation between the detected position and the stored position and the teaching point information.

11. The robot according to claim 10, wherein the robot corrects the teaching point information on the basis of the positional deviation and moves the arm.

12. The robot according to claim 11, wherein the robot corrects the teaching point information according to coordinate conversion.

13. The robot according to claim 1, wherein the robot moves the arm on the basis of a detected posture, which is a posture of the target object detected by the detecting section, and the detected position and a stored posture, which is a posture of the target object stored by the storing section, and the stored position.

14. A robot system comprising:
the robot according to claim 1; and
a robot control device configured to control the robot.

15. A robot system comprising:
the robot according to claim 2; and
a robot control device configured to control the robot.

16. A robot system comprising:
the robot according to claim 3; and
a robot control device configured to control the robot.

17. A robot system comprising:
the robot according to claim 4; and
a robot control device configured to control the robot.

18. A robot system comprising:
the robot according to claim 5; and
a robot control device configured to control the robot.

19. A robot system comprising:
the robot according to claim 6; and
a robot control device configured to control the robot.

20. A robot system comprising:
the robot according to claim 7; and
a robot control device configured to control the robot.
